(19) United States
(12) Patent Application Publication
(10) Pub. No.: US 2023/0184558 A1
(43) Pub. Date: Jun. 15, 2023

(54) SYSTEM AND METHOD FOR GENERATING NAVIGATION DATA

(71) Applicant: HERE Global B.V., Eindhoven (NL)

(72) Inventors: Amol WAYCHAL, Navi Mumbai (IN); Shailendra SHETTY, Mumbai (IN)

(21) Appl. No.: 17/547,993

(22) Filed: Dec. 10, 2021

(51) Int. Cl. G01C 21/34; G01C 21/36

(52) U.S. Cl. CPC G01C 21/3461; G01C 21/3697; G01C 21/3647

(57) ABSTRACT

A system for generating navigation data is provided. The system, for example, may obtain route data associated with a region. The route data may include at least one route for navigation in the region. Further, the system may determine mask data associated with the at least one route or a portion thereof. The mask data may include data about whether a mask is worn or not on the at least one route or the portion thereof. Furthermore, the system may generate the navigation data for navigation in the region based on the determined mask data.

### TECHNOLOGICAL FIELD

The present disclosure generally relates to routing and navigation systems, and more particularly relates to methods and systems for generating navigation data in routing and navigation systems.

### BACKGROUND

The emergence of viral diseases (such as coronavirus related Covid-19) has put lives of public under severe threat, as these viral diseases spread at faster rates and create respiratory problems, which are sometimes fatal. Usually, the viral diseases spread at the faster rate in public places such as shopping malls, airports, hospitals, etc. For instance, an uninfected person may be infected with the viral disease when the uninfected person traverses through areas of the public places where an infected person has traversed.

Currently, there are various navigation techniques that aim to provide user guidance to navigate within public places. However, these navigation techniques may fail to provide user guidance by considering safety of the people from the viral diseases or the like.

### BRIEF SUMMARY OF SOME EXAMPLE EMBODIMENTS

In order to solve the foregoing problem(s), the present disclosure provides a system for generating the navigation data for navigation in a region. As used herein, the region may correspond any point-of-interest (POI) such as fueling stations, hotels, hospitals, restaurants, museums, stadiums, airports, offices, auto repair shops, buildings, stores, parks, indoor regions within malls, offices, buildings, facilities, etc. In various embodiments, the generated navigation data may include a safest route for the navigation in the region. As used herein, the safest route may correspond to a route in which precautionary protocols have been taken to ensure safety from infectious diseases such as COVID or the like. In order to generate the navigation data, various embodiments are provided for obtaining route data associated with the region. The route data may comprise at least one route to navigate in the region.

Various embodiments are provided for determining mask data associated with the at least one route or a portion thereof. For instance, a portion of the at least one route may correspond to a path segment. As used herein, the path segment may be a segment or a link in which a person (or a pedestrian) is allowed to walk. The determined mask data may comprise data about whether a mask is worn or not in the at least one route or the portion thereof.

Various embodiments are provided for determining sanitization data associated with the at least one route or the portion thereof. The sanitization data may include data about sanitization performed for the at least one route or the portion thereof. As used herein, the ‘sanitization’ may correspond to cleaning, washing, or disinfecting the at least one route with chemicals such as soap, detergents, or any other chemical composition with a predetermined percentage of alcohol.

Various embodiments are provided for generating the navigation data for navigation in the region, based on one or a combination of the determined mask data and the determined sanitization data. In various embodiments, the generated navigation data may be used for the navigation in the region such that the pedestrian (the person) have a less chance of being exposed to the infectious diseases.

A system, a method and a computer programmable product are provided in accordance with an example embodiment described herein for generating the navigation data.

In one aspect, a system for generating navigation data is disclosed. The system comprises a memory configured to store computer-executable instructions; and at least one processor configured to execute the computer-executable instructions to: obtain route data associated with a region, where the route data comprises at least one route for navigation in the region; determine mask data associated with the at least one route or a portion thereof, where the mask data comprises data about whether a mask is worn or not on the at least one route or the portion thereof and generate the navigation data for navigation in the region, based on the determined mask data.

In additional system embodiments, to generate the navigation data based on the mask data, the at least one processor is configured to: compute a safety value for each of the at least one route or the portion thereof to produce a safety value set; and generate the navigation data for the navigation in the region, based on the safety value set.

In additional system embodiments, to generate the navigation data based on the safety value set, the at least one processor is configured to: identify a route that is associated with highest safety value in the safety value set, as a safest route; and generate the navigation data comprising the safest route and the safety value associated with the safest route.

In additional system embodiments, the at least one processor is further configured to: identify a route that is associated with the lowest safety value as a vulnerable route; and generate a notification to sanitize the vulnerable route.

In additional system embodiments, the mask data further comprises a count of individuals wearing the mask in each of the at least one route or the portion thereof. In order to produce the safety value set, the at least one processor is configured to: determine, using video data associated with the region, a total count of individuals in each of the at least one route or the portion thereof, compute, for each of the at least one route or the portion thereof, a ratio of (i) the count of individuals wearing the mask and (ii) the total count of individuals; compute the safety value for each of the at least one route or the portion thereof, based on the computed ratio.

In additional system embodiments, the at least one processor is further configured to: determine sanitization data associated with the at least one route or the portion thereof, based on the video data, where the sanitization data comprises one or a combination of: (i) a frequency of a cleaning performed for the at least one route or the portion thereof, (ii) a time-stamp associated with each cleaning, and (iii) a cleaning-type associated with each cleaning; and compute the safety value for each of the at least one route, based on one or a combination of the computed ratio and the sanitization data.

In additional system embodiments, to compute the safety value for a particular route or the portion thereof, the at least one processor is further configured to: determine a first weight value and a second weight value for the particular route or the portion thereof, based on time-stamp data associated with the video data; determine a first weighted value based on the first weight value and the ratio associated with the particular route or the portion thereof; determine a second weighted value based on the second weight value and the frequency of sanitization associated with the particular route or the portion thereof, and compute the safety value for the particular route or the portion thereof based on a combination of the first weighted value and the second weighted value.

In additional system embodiments, the time-stamp data comprises a timestamp associated with time of day at which a recent sanitization is performed for the particular route or the portion thereof.

In additional system embodiments, the at least one processor is further configured to provide at least one navigation instruction to reach a destination location in the region, based on the generated navigation data.

In another aspect, a method for providing navigation guidance is disclosed. The method comprises: obtaining route data associated with a region, where the route data comprises at least one route for navigation in the region; determining sanitization data associated with the at least one route or a portion thereof, where the sanitization data comprises data about a cleaning performed for the at least one route or the portion thereof; and providing navigation guidance for navigation in the region, based on the determined sanitization data.

In additional method embodiments, providing navigation guidance based on the determined sanitization data comprises: computing a safety value for each of the at least one route or the portion thereof to produce a safety value set; generating navigation data, based on the safety value set; and providing navigation guidance, based on the navigation data.

In additional method embodiments, generating the navigation data based on the safety value set comprises: identifying a route that is associated with the highest safety value in the safety value set as the safest route; and generating the navigation data comprising the safest route and the safety value associated with the safest route.

In additional method embodiments, the method further comprises: identifying a route that is associated with the lowest safety value in the safety value set as a vulnerable route; and generating a notification to sanitize the vulnerable route.

In additional method embodiments, producing the safety value set comprises: determining mask data associated with the at least one route or the portion thereof, using video data associated with the region, where the mask data comprises a count of individuals wearing a mask in each of the at least one route or the portion thereof; determining, using the video data, a total count of individuals in each of the at least one route; computing, for each of the at least one route or the portion thereof, a ratio of (i) the count of individuals wearing the mask and (ii) the total count of individuals; and computing the safety value for each of the at least one route, based on one or a combination of the computed ratio and the sanitization data.

In additional method embodiments, the sanitization data further comprises one or a combination of: (i) a frequency of the cleaning performed for the at least one route or the portion thereof, (ii) a timestamp associated with each cleaning, and (iii) a cleaning-type associated with each cleaning. In order for computing the safety value for a particular route or the portion thereof, the method comprises: determining a first weight value and a second weight value for the particular route, based on time-stamp data associated with the video data; determining a first weighted value based on the first weight value and the ratio associated with the particular route; determining a second weighted value based on the second weight value and the frequency of sanitization associated with the particular route; and computing the safety value for the particular route based on a combination of the first weighted value and the second weighted value.

In additional method embodiments, the time-stamp data comprises a timestamp associated with time of day at which a recent sanitization is performed for the particular route.

In yet another aspect, a computer program product comprising instructions or a non-transitory computer readable medium having stored thereon computer executable instructions which when executed by at least one processor, cause the at least one processor to carry out operations for determining a route, the operations comprising: determining one or a combination of mask data and sanitization data associated with one or more path segments of a region, where: (i) the mask data comprises data about whether a mask is worn or not on the one or more path segments, and (ii) the sanitization data comprises data about a cleaning performed for the one or more path segments; determining the route, as a function of the one or more path segments, for navigation in the region, based on at least one of the determined mask data, the sanitization data, or a combination thereof; and outputting the determined route.

In additional computer program product embodiments, for determining the route based on at least one of the determined mask data, the sanitization data, or a combination thereof, the operations further comprise: computing a safety value for each of the one or more path segments to produce a safety value set; and determining the route for the navigation in the region, based on the safety value set.

In additional computer program product embodiments, the mask data further comprises a count of individuals wearing the mask in each of the one or more path segments, where the sanitization data further comprises one or a combination of: (i) a frequency of the cleaning performed for each of the one or more path segments, (ii) a timestamp associated with each cleaning, and (iii) a cleaning-type associated with each cleaning. In order for producing the safety value set, the operations further comprise: determining, using video data associated with the region, a total count of individuals in each of the one or more path segments; computing, for each of the one or more path segments, a ratio of (i) the count of individuals wearing the mask and (ii) the total count of individuals; and computing the safety value for each of the one or more path segments, based on one or a combination of the computed ratio and the sanitization data.

In additional computer program product embodiments, for computing the safety value for a particular path segment, the operations further comprising: determining a first weight value and a second weight value for the particular path segment, based on time-stamp data associated with the video data; determining a first weighted value based on the first weight value and the ratio associated with the particular path segment; determining a second weighted value based on the second weight value with the frequency of sanitization associated with the particular path segment; and computing the safety value for the particular path segment based on a combination of the first weighted value and the second weighted value.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for generating navigation data, in accordance with one or more example embodiments;

FIG. 2A illustrates a block diagram showing a layout of a region, in accordance with one or more example embodiments;

FIG. 2B illustrates a diagram for processing the layout, in accordance with one or more example embodiments;

FIG. 2C illustrates a diagram for determining one or more routes between two locations, in accordance with one or more example embodiments;

FIG. 2D illustrates a diagram for storing the one or more routes in a map database, in accordance with one or more example embodiments;

FIG. 3 illustrates a block diagram of the system for generating the navigation data, in accordance with one or more example embodiment;

FIG. 4A illustrates a working environment of the system for generating the navigation data, in accordance with one or more example embodiments;

FIG. 4B illustrates a diagram for generating the navigation data based on video data and the one or more routes associated with the region, in accordance with one or more example embodiments;

FIG. 4C illustrates a diagram for generating the navigation data based on the video data and path segments associated with the region, in accordance with one or more example embodiments;

FIG. 4D illustrates a diagram showing a visual representation of the generated navigation data based on percentage safety values associated with different routes of navigation, in accordance with one or more example embodiments;

FIG. 5 illustrates a flowchart depicting a method for generating the navigation data, in accordance with one or more example embodiments;

FIG. 6 illustrates another flowchart depicting a method for generating the navigation data, in accordance with one or more example embodiments; and

FIG. 7 illustrates yet another flowchart depicting a method for generating the navigation data, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium” refers to a non-transitory physical storage medium (for example, volatile or non-volatile memory device), which may be differentiated from a “computer-readable transmission medium” that refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for generating the navigation data. The generated navigation data may include a safest route for the navigation in a region. As used herein, the region may correspond any point-of-interest (POI) such as fueling stations, hotels, hospitals, restaurants, museums, stadiums, airports, offices, auto repair shops, buildings, stores, parks, etc. As used herein, the safest route may correspond may be a route in which precautionary protocols have been taken to ensure safety from infectious diseases such as COVID or the like. In order to generate the navigation data, various embodiments are provided for obtaining route data associated with the region. The route data may comprise at least one route to navigate in the region.

Various embodiments are provided for determining mask data associated with the at least one route or a portion thereof. For instance, a portion of the at least one route may correspond to a path segment. As used herein, the path segment may be a segment or a link in which a person (or a pedestrian) is allowed to walk. The determined mask data may comprise data about whether a mask is worn or not in the at least one route or the portion thereof.

Various embodiments are provided for determining sanitization data associated with the at least one route or the portion thereof. The sanitization data may include data about sanitization performed for the at least one route or the portion thereof. As used herein, the ‘sanitization’ may correspond to cleaning, washing, or disinfecting the at least one route with chemicals such as soap, detergents, or any other chemical composition with a predetermined percentage of alcohol.

Various embodiments are provided for generating the navigation data for navigation in the region, based on one or a combination of the determined mask data and the determined sanitization data. In various embodiments, the generated navigation data may be used for the navigation in the region such that the pedestrian (the person) have a less chance of being exposed to the infectious diseases.

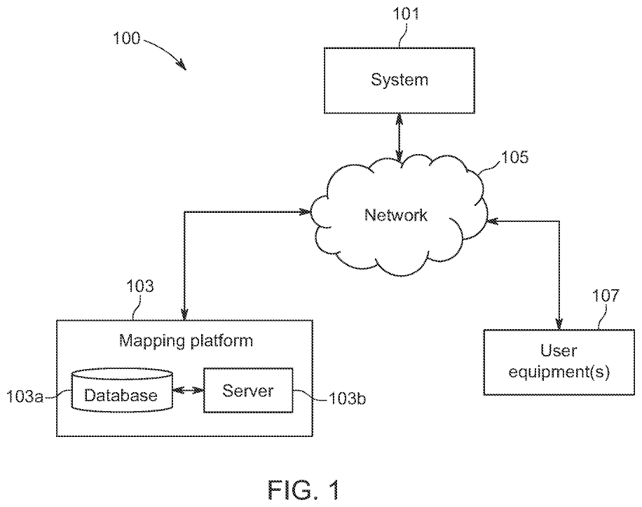

FIG. 1 illustrates a block diagram 100 showing a network environment of a system 101 for generating navigation data, in accordance with one or more example embodiments. The system 101 may be communicatively coupled, via a network 105, to one or more of a mapping platform 103 and/or at least one user equipment 107. Additionally, the components described in the block diagram 100 may include one or multiple imaging devices such as closed-circuit television cameras, video recorders, or the like. In these embodiments, the system 101 may be communicatively coupled to the one or multiple image devices via the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

Further, one or more components described in the block diagram 100 may be rearranged, changed, and/or removed without deviating from the scope of the present disclosure. In an example embodiment, the system 101 may be embodied in one or more of several ways as per the required implementation. For example, the system 101 may be embodied as a cloud-based service, a cloud-based application, a cloud-based platform, a remote server-based service, a remote server-based application, a remote server-based platform, or a virtual computing system. As such, the system 101 may be configured to operate inside the mapping platform 103 and/or inside the at least one user equipment 107.

In some embodiments, the system 101 may be embodied within the at least one user equipment 107, for example as a part of a navigation system, a navigation app in a mobile device and the like. In each of such embodiments, the system 101 may be communicatively coupled to the components shown in FIG. 1 to conduct the desired operations and wherever required modifications may be possible within the scope of the present disclosure. The at least one user equipment 107 may be any user accessible device such as a mobile phone, a smartphone, a smart-wearable device (e.g. smart-watches, smart-glasses, etc.), a portable computer, and the like. The at least one user equipment 107 may be associated with at least one user such as a pedestrian, a person, or the like. The at least one user equipment 107 may include a processing means such as a central processing unit (CPU), storage means such as on-board read only memory (ROM) and random access memory (RAM), acoustic sensors such as a microphone array, position sensors such as a GPS sensor, gyroscope, motion sensors such as accelerometer, a display enabled user interface such as a touch screen display, and/or other components as may be required for specific functionalities of the at least one user equipment 107. For example, the at least one user equipment 107 may be configured to execute and run mobile applications such as a messaging application, a browser application, a navigation application, and the like.

In some other embodiments, the system 101 may be a server 103b of the mapping platform 103 and therefore may be co-located with or within the mapping platform 103. In yet some other embodiments, the system 101 may be a standalone unit configured to generate the navigation data. The mapping platform 103 may include a map database 103a (also referred to as a geographic database 103a) for storing map data and a processing server 103b for conducting the processing functions associated with the mapping platform 103. For example, the processing sever 103b may include one or more processors configured to process requests received from the at least one user equipment 107. The processing server 103b may fetch the map data from the map database 103a and transmit the same to the at least one user equipment 107 in a format suitable for use by the at least one user equipment 107. In one or more example embodiments, the mapping platform 103 may periodically communicate with the at least one user equipment 107 via the processing server 103b to update a local cache of the map data stored on the at least one user equipment 107. Accordingly, the map data may also be stored on the at least one user equipment 107 and may be updated based on periodic communication with the mapping platform 103.

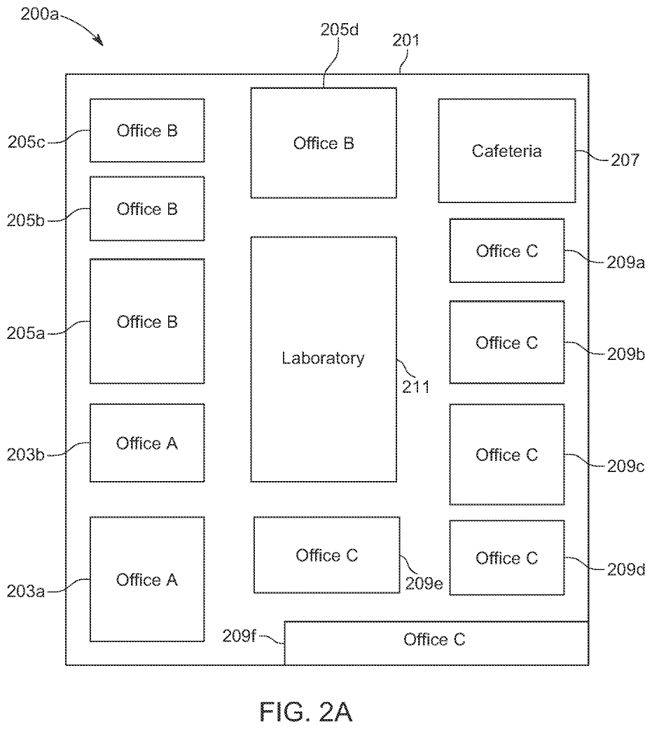

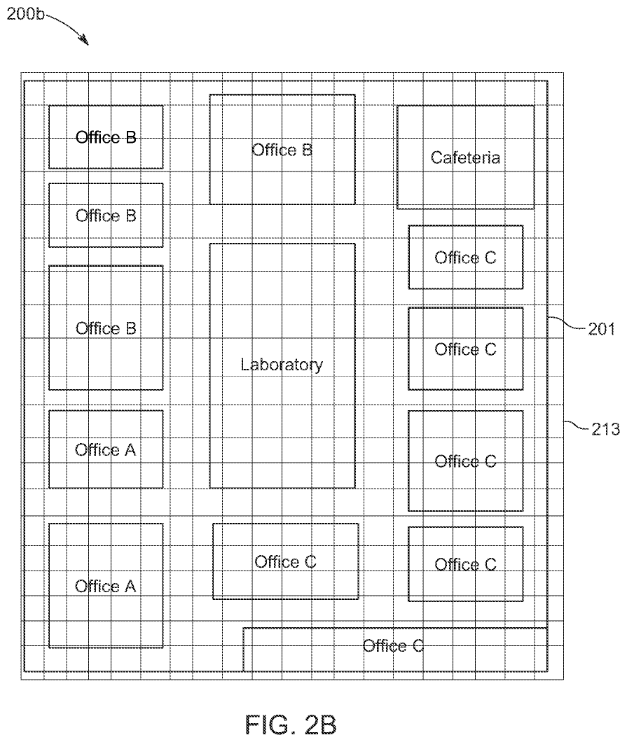

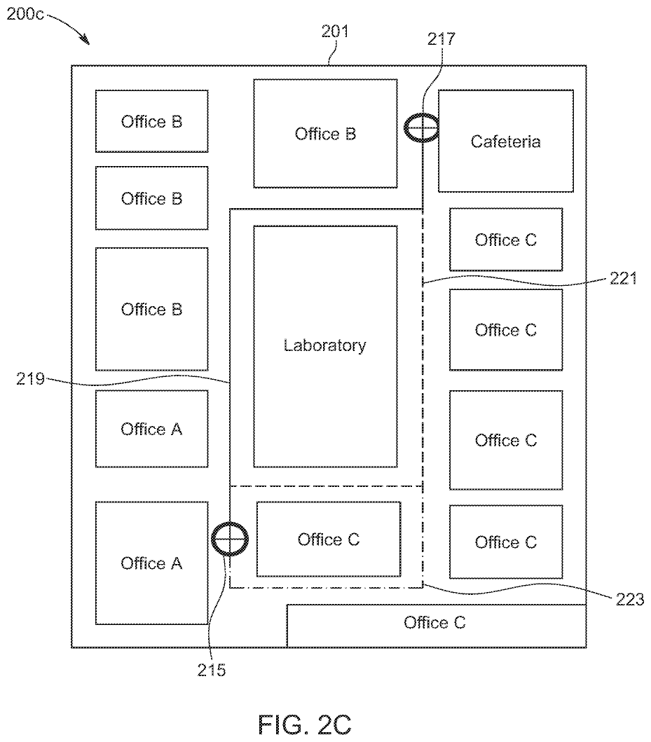

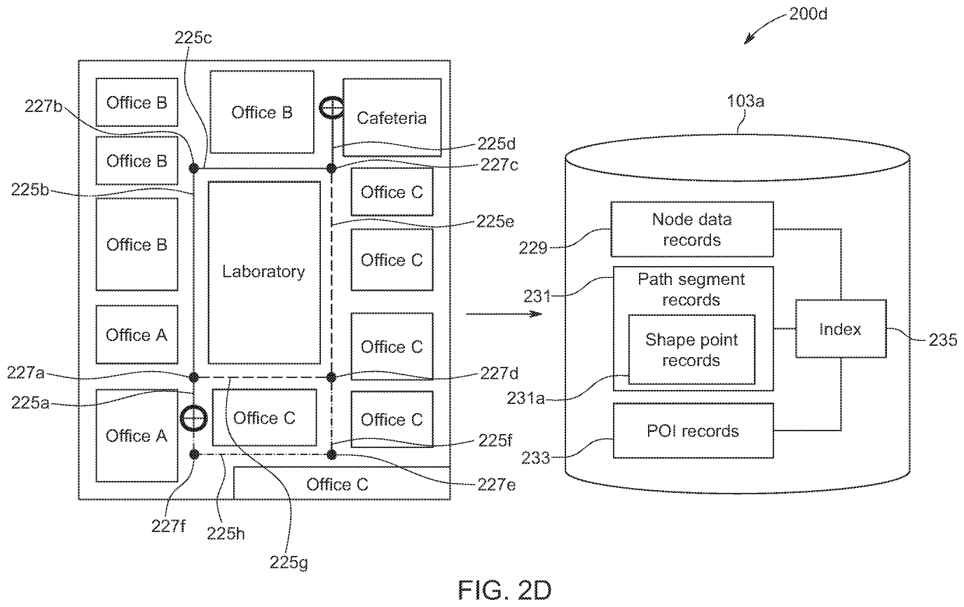

In some embodiments, to generate and store the map data in one or a combination of the map data base 103a and the at least one user equipment 107, the processing server 103b may receive one or multiple layouts corresponding to one or more regions from one or more image sources. For instance, the one or more image sources may correspond to a website, an application, a workstation or a computer, a database, and/or any other hardware and/or software component that can store or include images (i.e., image data) representing layout(s) of one or more regions. As used herein, ‘region’ may correspond any point of interest (POI) such as fueling stations, hotels, restaurants, museums, stadiums, airports, offices, auto repair shops, buildings, stores, parks, an indoor environment such as indoor area of a mall, an office complex, an airport, a hospital etc. For example, the layout of a particular region that is obtained from the one or more image sources is as shown in FIG. 2A.

FIG. 2A illustrates a block diagram 200a showing a layout 201 of the region, in accordance with one or more example embodiments. For instance, the layout 201 may be an image received by the mapping platform 103 from the one or more image sources. As used herein, the image may correspond to a raster or pixel-based image, such as a JPEG, Bitmap, Pixmap, Tiff, or other pixel or raster-based file format. Additionally, the image may be raster or pixilated scanned copy of a paper or hard layout. Alternatively, the image may be vector based or vectorized images.

According to an embodiment, the layout 201 may be a representation that illustrates any real-world region in which a person or pedestrian is allowed to walk and/or move about. For instance, the layout may be a representation of the office buildings, such as a first floor or other floor. Additionally, the layout 201 may be a representation of future real-world regions that have not been built yet. In an example embodiment, the layout 201 may include graphical representations or icons of areas, spaces, and/or designations in the region. For example, the layout 201 may include a first set of offices 203a and 203b, a second set of offices 205a, 205b, 205c, and 205d, a cafeteria 207, a third set of office rooms 209a, 209b, 209c, 209d, 209e, and 209f, and a laboratory 211.

In an embodiment, the mapping platform 103 (or the system 101) may process the layout 201 to generate and store the map data in one or a combination of the map data base 103a and the at least one user equipment 107. For instance, the mapping platform 103 may process the layout 201 as explained in the detailed description of FIG. 2B.

FIG. 2B illustrates a diagram 200b for processing the layout 201, in accordance with one or more example embodiments. According to an embodiment, the mapping platform 103 (or the system 101) may apply a grid (also referred to as a mesh) 213 on or over the layout 201 or a copy of the layout 201. The grid 213 may be an array of geometric shapes (e.g., uniform sized geometric shapes) such as tiles, blocks, or sections. The grid 213 may cover an entire ground region of the layout 201. As used herein, the ground region refers to a surface, a floor, or a portion thereof that can be walked upon as well as the surface in which objects or barriers may be placed or positioned on or over. For exemplary purpose, the tiles having substantially rectangular or square shape of uniform size is considered. Alternatively, the tiles may have circular, triangular, or other polygonal shape of varied sizes at various locations rather than being uniform.

Further, the tiles of the grid 213 may be assigned with coordinates such as local or global coordinates. For example, each tile of the grid 213 may be assigned with a coordinate a (x, y), latitude and longitude, or other coordinate designation. One of the tiles, for example, a corner tile of the grid 213 may be designated as an origin point (0,0) for reference and positing purposes. The association of the coordinates to the tiles allows items, features, or areas of the region to be searchable. Once the tiles are assigned with the coordinates, the mapping platform 103 may classify the tiles of the grid 213 as navigable tiles and/or non-navigable tiles. For instance, the navigable tiles may correspond to tiles that reference a navigable portion of the ground region in which the person is allowed to walk. Conversely, the non-navigable tiles may correspond to tiles that reference a non-navigable portion of the ground region in which the person is not allowed to walk. For instance, non-navigation portion may be a portion of the region that is associated with walls of the rooms, objects, and/or barriers. The navigable portion may be a portion of the region that is not associated with the walls of the rooms, objects, and/or barriers. In an example embodiment, the mapping platform 103 may classify the tiles of the grid 213 as the navigable tiles and/or the non-navigable tiles based on pixel values associated with pixels of the image representing the layout 201. For example, a particular tile of the grid 213 may be classified as the non-navigable tile, if a predetermined number of pixels within the particular tile has a pixel value that represent the walls of the rooms, objects, barriers and/or the like. Alternatively, a map developer may select the non-navigable tiles. Once the tiles of the grid 213 are classified as the navigable tiles and the non-navigable tiles, the mapping platform 103 may determine one or more routes between any two locations within the region represented by the layout 201. For instance, the two locations may be provided by the user (e.g., the pedestrian) or the map developer. For example, the mapping platform 103 may determine the one or more routes between two locations as a function of the tiles.

FIG. 2C illustrates a diagram 200c for determining one or more routes 219, 221, and 223 between two locations 215 and 217, in accordance with one or more example embodiments. According to an embodiment, when the mapping platform 103 receive location information of the two locations 215 and 217, the mapping platform 103 may be configured to determine the one or more routes 219, 221, and 223 between the locations 215 and 217. For example, the mapping platform 103 may determine the one or more routes 219, 221, and 223 by determining adjacent navigable tiles that connect the locations 215 and 217. For instance, the adjacent navigable tiles that connect the locations 215 and 217 may be determined by executing one or more of Dijkstra algorithm, A-star algorithm, and/or any other route exploring algorithm.

Once the one or more routes 219, 221, and 223 are determined, the mapping platform 103 may be configured to store the one or more routes 219, 221, and 223 in the map database 103a. For example, the mapping platform 103 may store the one or more routes 219, 221, and 223 in the map database 103a as explained in the detailed description of FIG. 2D.

FIG. 2D illustrates a diagram 200d for storing the one or more routes 219, 221, and 223 or portions thereof in the map database 103a, in accordance with one or more example embodiments. FIG. 2D is explained in conjunction with FIG. 2C. In an example embodiment, each of the one or more routes 219, 221, and 223 may be referenced by at least two nodes and one or more path segments (e.g., as an alternative to the tile-based routing). For example, the route 219 may be referenced by nodes 227a, 227b, and 227c and path segments 225a, 225b, 225c, and 225d. The route 221 may be referenced by nodes 227a, 227d, and 227c and path segments 225a, 225g, 225e, and 225d. The route 223 may be referenced by nodes 227f, 227e, 227d, and 227c and path segments 225a, 225h, 225f, 225e, and 225d. As used herein, ‘path segment’ may correspond to a segment or a link between two nodes in which the user is allowed to walk. As used herein, ‘node’ may correspond to an intersection where two or more path segments meet.

In one embodiment, each of the one or more routes 219, 221, and 223 or portions thereof may be stored in the map database 103a using their corresponding nodes and path segments. To this end, the map database 103a may be provided with node data records 229, path segment records 231, and POI records 233. For instance, the node data records 229 may store data about the nodes (e.g., intersection points or an end of a segment or link). The path segment records 231 may store data about the path segments or links. Additionally, the path segment records 231 may include shape point records 231a for storing shape points that define a curvature nature of the path segment. The POI records 233 may store data about the POI (i.e., a point of interest in the region, such as a specific office or meeting room for an indoor environment). The map database 103a may include POI data about places, such as cities, towns, and/or geographic features such as bodies of water, mountain ranges, etc.

The node data records 229 and/or shape point records 231a may be associated with node IDs or shape point IDs respectively, by which the record may be identified in the map database 103a. The path segment records 231 may be associated with segment IDs by which the record may be identified in the map database 103a. Also, the path segment records 231 may include data for identifying the endpoints (i.e., respective nodes) of the path segments. The path segment records 231, the node data records 229, and/or the POI records 233 may be associated with attributes such as geographic coordinates (such as latitude, longitude, and/or altitude or other coordinates), other positioning information (such as local or indoor positioning data), street or path names or location or structure names, address ranges, and other navigation related attributes. For example, the node data records 229 and/or the shape point records 231a may be associated with the coordinates or other position information. The path segment records 231 may be associated with distance or length information and/or time information such as an average time to traverse that particular path segment. The POI records 233 may be associated the node data records 229 and the path segment records 231 via an index 235. The index 235 may be one or more data structures that connect different data records with each other.

The map database 103a may be maintained by the map developer such as HERE Technologies. The map developer may collect route data to generate and enhance the map data stored in the map database 103a. As used herein, the route data may correspond to one or more routes between any two locations in the region. As used herein, the map data may correspond to a combination of data stored in each of the node data records 229, the path segment records 231, and/or the POI records 233.

The map database 103a may be a master database stored in a format that facilitates updating, maintenance, and development. For example, the master database or the map data in the master database 103a is in an Oracle spatial format or other spatial format, such as for development or production purposes. The Oracle spatial format or development/production database may be compiled into a delivery format, such as a GDF format. The data in the production and/or delivery formats may be compiled or further compiled to form geographic database products or databases, which may be used in end user navigation devices or systems.

For example, the map data is compiled (such as into a PSF format) to organize and/or configure the data for performing navigation-related functions and/or services, such as route calculation, route guidance, map display, distance and travel time functions, and other functions, by a navigation device. The navigation-related functions may correspond to a pedestrian navigation, or other types of navigation. The compilation to produce the compiled product databases may be performed by a party or entity separate from the map developer. For example, a customer of the map developer, such as a navigation device developer or other end user device developer, may perform compilation on a received geographic database in a delivery format to produce one or more compiled navigation databases.

In this way, the map data may be generated and stored within the map database 103a and/or the user equipment 107. Here for exemplary purpose, the mapping platform 103 determining the one or more routes 219, 221, and 223 between the locations 215 and 217 is considered. However, to generate/update the map database 103a, the mapping platform 103 may determine the one or more routes for any two locations as similarly explained with respect to the locations 215 and 217. Here for the purpose of explanation, the region is considered to be the office buildings. However, the region may include any POI such as hotels, hospitals, restaurants, museums, stadiums, airports, fueling stations, auto repair shops, stores, parks, etc.

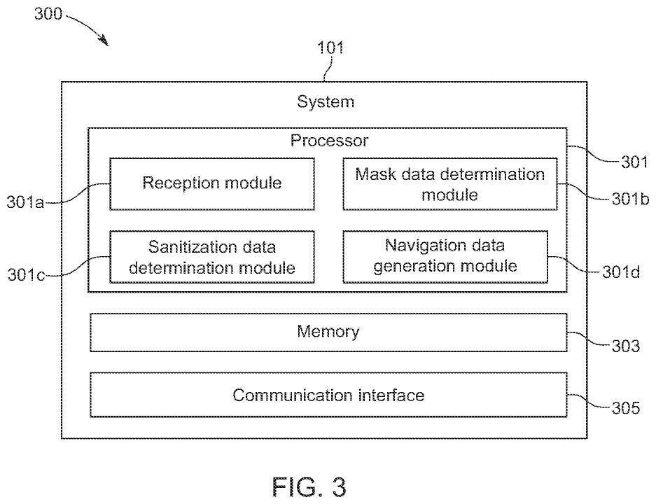

Further, the map data of the map database 103a may be used to provide one or more navigation functions, for example, the pedestrian navigation within the POI (i.e., the region). It is an objective of the disclosed system 101 to generate the navigation data for the navigation within the region such that the generated navigation data includes the safest route to traverse from one location to another location. As used herein, the safest route may be a route in which precautionary protocols have been taken for ensuring safety from infectious diseases such as coronavirus disease (COVID) or the like. For example, the system 101 for generating the navigation data is as explained in the detailed description of FIG. 3.

FIG. 3 illustrates a block diagram 300 of the system 101 for generating the navigation data, in accordance with one or more example embodiment. The system 101 may include at least one processor 301, a memory 303, and a communication interface 305. Further, the system 101 may include a reception module 301a, a mask data determination module 301b, a sanitization data determination module 301c, and a navigation data generation module 301d. In an embodiment, the reception module 301a may be configured to obtain the route data associated with the region. The route data may comprise at least one route (e.g., the routes 219, 221, and 223) for the navigation in the region. In an embodiment, the route may be defined by two locations, where a first location of the two locations may be a current location of the user (e.g., the pedestrian) and a second location of the two locations may be a destination location where the user is willing to go in the region.

In an embodiment, the mask determination module 301b may be configured to determine mask data associated with the at least one route or a portion thereof. The mask data may comprise data about whether a mask is worn or not on the at least one route or the portion thereof. As used herein, the portion of the at least route may correspond to at least one path segment associated with the at least one route. In an embodiment, the sanitization data determination module 301c may be configured to determine sanitization data associated with the at least one route or the portion thereof. The sanitization data may comprise data about sanitization performed for the at least one route or the portion thereof. As used herein, the sanitization may correspond to cleaning, washing, or disinfecting the at least one route with chemicals such as soap, detergents, or any other chemical composition with a predetermined percentage of alcohol. In an embodiment, the navigation data generation module 301d may be configured to generate the navigation data for the navigation within the region, based on one or a combination of the mask data or the sanitization data. In an example embodiment, the generated navigation data may comprise the safest route for navigating within the region from one location to another location. For instance, the safest route may be the route in which the precautionary protocols (like wearing masks, frequent sanitization, and the like) have been taken for ensuring safety from the infectious diseases.

According to an embodiment, each of the modules 301a-301d may be embodied in the processor 301 or one or more different processors. The processor 301 may retrieve computer-executable instructions that may be stored in the memory 303 for execution of the computer-executable instructions, which when executed configures the processor 301 for generating the navigation data.

The processor 301 may be embodied in a number of diverse ways. For example, the processor 301 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 301 may include one or more processing cores configured to perform independently. A multi-core processor may enable multiprocessing within a single physical package. Additionally, or alternatively, the processor 301 may include one or more processors configured in tandem via the bus to enable independent execution of instructions, pipelining and/or multithreading.

Additionally, or alternatively, the processor 301 may include one or more processors capable of processing large volumes of workloads and operations to provide support for big data analysis. In an example embodiment, the processor 301 may be in communication with the memory 303 via a bus for passing information to mapping platform 103. The memory 303 may be non-transitory and may include, for example, one or more volatile and/or non-volatile memories. In other words, for example, the memory 303 may be an electronic storage device (for example, a computer readable storage medium) comprising gates configured to store data (for example, bits) that may be retrievable by a machine (for example, a computing device like the processor 301). The memory 303 may be configured to store information, data, content, applications, instructions, or the like, for enabling the system 101 to conduct various functions in accordance with an example embodiment of the present disclosure. For example, the memory 303 may be configured to buffer input data for processing by the processor 301. As exemplarily illustrated in FIG. 3, the memory 303 may be configured to store instructions for execution by the processor 301. As such, whether configured by hardware or software methods, or by a combination thereof, the processor 301 may represent an entity (for example, physically embodied in circuitry) capable of performing operations according to an embodiment of the present disclosure while configured accordingly. Thus, for example, when the processor 301 is embodied as an ASIC, FPGA or the like, the processor 301 may be specifically configured hardware for conducting the operations described herein. Alternatively, as another example, when the processor 301 is embodied as an executor of software instructions, the instructions may specifically configure the processor 301 to perform the algorithms and/or operations described herein when the instructions are executed. However, in some cases, the processor 301 may be a processor specific device (for example, a mobile terminal or a fixed computing device) configured to employ an embodiment of the present disclosure by further configuration of the processor 301 by instructions for performing the algorithms and/or operations described herein. The processor 301 may include, among other things, a clock, an arithmetic logic unit (ALU) and logic gates configured to support operation of the processor 301.

In some embodiments, the processor 301 may be configured to provide Internet-of-Things (IoT) related capabilities to a user of the system 101, where the user may be a pedestrian, a person, or the like. The IoT related capabilities may in turn be used to provide smart navigation solutions by providing real time updates to the user for navigating from one location to another location. The system 101 may be accessed using the communication interface 305. The communication interface 305 may provide an interface for accessing various features and data stored in the system 101. For example, the communication interface 305 may include I/O interface which may be in the form of a GUI, a touch interface, a voice enabled interface, a keypad, and the like. For example, the communication interface 305 may be a touch enabled interface of a navigation device, which may also display various navigation related data to the user. Such navigation related data may include information about the route, a route display, turn-maneuvers associated with the route, and the like.

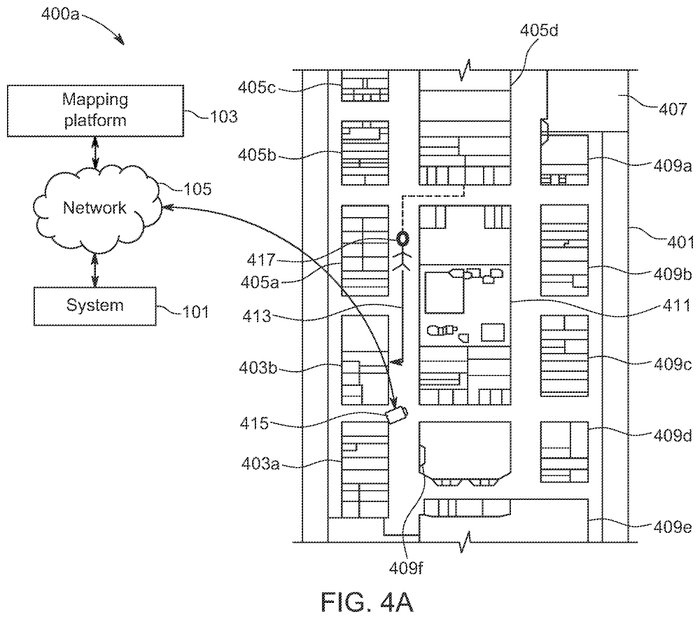

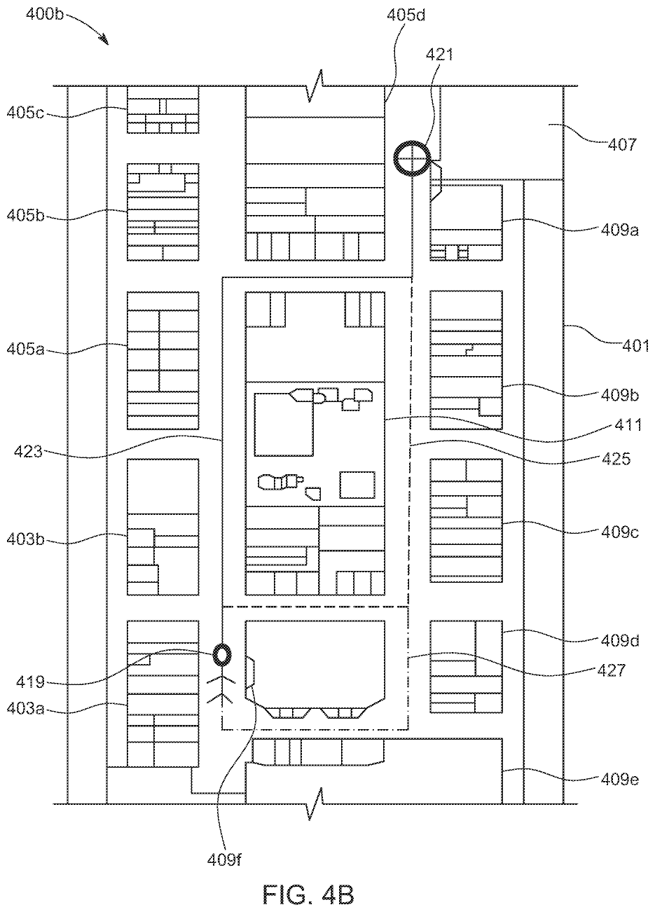

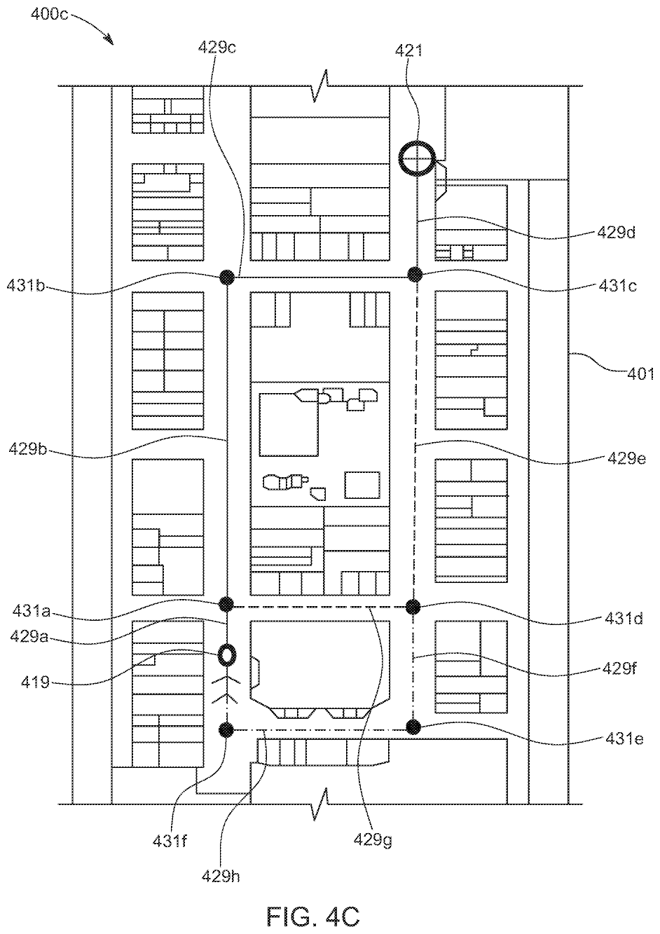

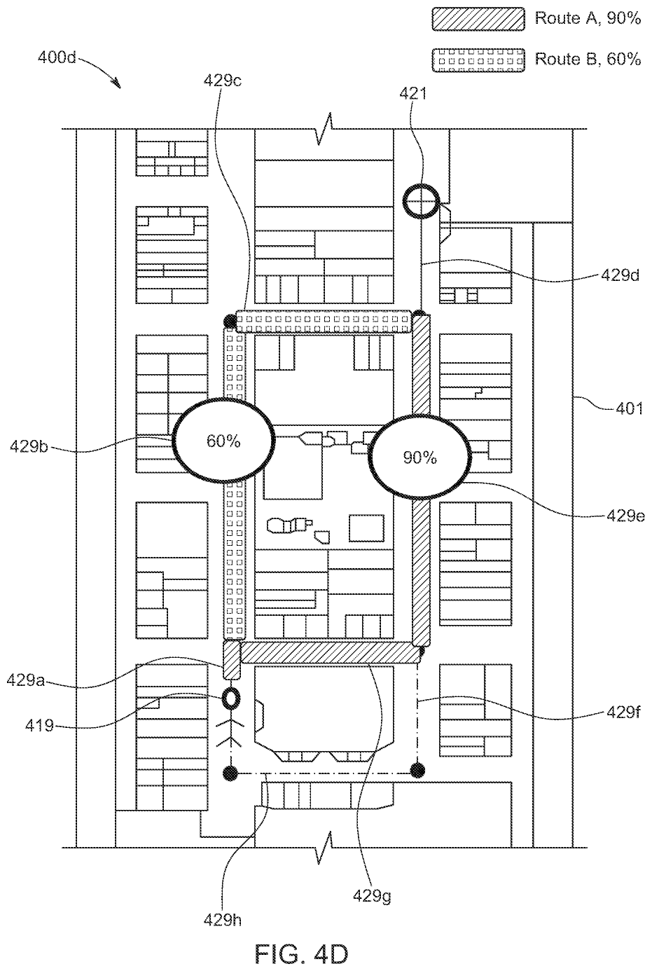

FIG. 4A illustrates a working environment 400a of the system 101 for generating the navigation data, in accordance with one or more example embodiments. As illustrated in FIG. 4A, the working environment 400a may include the system 101, the mapping platform 103, the network 105, and a region 401. For instance, the region 401 may be a group of offices in an indoor environment such as in a building. Alternatively, the region 401 may be any area or POI such as fueling stations, hotels, restaurants, hospitals, museums, stadiums, airports, auto repair shops, buildings, stores, parks, etc. The region 401 may include a first set of offices 403a and 403b, a second set of offices 405a, 405b, 405c, and 405d, a cafeteria 407, a third set of offices 409a, 409b, 409c, 409d, 409e, and 409f, and a laboratory 411. Further, the region 401 may include various routes (such as a route 413) for a pedestrian navigation from one location to another location within the region 401. In various embodiments, the region 401 may be installed with one or more imaging devices (such as an imaging device 415) to monitor the pedestrian or people who are traversing through the routes of the region 401. For instance, the imaging device 415 may be a CCTV camera, a video recorder, a surveillance camera, or the like. In various embodiments, the one or more imaging devices (e.g., the imaging device 415) may be in communication with the system 101 via the network 105. For instance, the one or more imaging devices may transmit video data to the system 101. In an example embodiment, the video data may include image frames having the pedestrian(s) (such as a pedestrian 417) or the people who are traversing through the routes of the region 401.

For example, if the pedestrian 417 is suffering from the infectious diseases and the pedestrian 417 is walking in the route 413 without wearing the mask, then a next pedestrian who walks through the same route 413 may be infected from the infectious diseases. In order to avoid spread of the infectious diseases, it is an objective of the system 101 to generate the navigation data for navigating the next pedestrian safely. In various embodiments, the navigation data may be generated using the video data obtained from the one or more imaging devices. The generated navigation data may include a safest route for navigating the next pedestrian. As used herein, the safest route may be a route in which the precautionary protocols (such as wearing masks, frequent sanitization, and the like) have been taken for ensuring safety from the infectious diseases. For instance, the system 101 may generate the navigation data for the pedestrian navigation using the video data as explained in the detailed description of FIG. 4B and FIG. 4C.

FIG. 4B illustrates a diagram 400b for generating the navigation data based on the video data and one or more routes associated with the region 401, in accordance with one or more example embodiments. As illustrated in FIG. 4B, the diagram 400b may include the region 401 having the first set of offices 403a and 403b, the second set of offices 405a, 405b, 405c, and 405d, the cafeteria 407, the third set of offices 409a, 409b, 409c, 409d, 409e, and 409f, and the laboratory 411. For example, if an employee or a pedestrian (such as a pedestrian 419) associated with the first office 403a wishes to visit the cafeteria 407, the pedestrian 419 may set their destination location information to be destination location 421 (such as selecting the cafeteria 407) using user equipment (such as the user equipment 107). In this case, the starting location may be pedestrian's current location. Alternatively, the pedestrian 419 or device thereof may also set the starting location using the user equipment 107. The starting location may be a current location automatically detected by the user equipment 107. For instance, the pedestrian 419 may be different from the pedestrian 417.

Once the starting location and the destination location 421 are set, the user equipment 107 may communicate the starting location and the destination location 421 to the system 101. The system 101 may be configured to obtain route data for the starting location and the destination location 421 of the region 401. In an example embodiment, the system 101 may obtain the route data from the map database 103a. In another example embodiment, the system 101 may generate the route data for the starting location and the destination location 421 of the region 401 as explained in the detailed description of FIG. 2A—FIG. 2D. In an example embodiment, the route data may comprise one or more routes (such as routes 423, 425, and 427) for navigating from the starting location to the destination location 421. For instance, the routes 423, 425, and 427 may correspond to the routes 219, 221, and 223 respectively explained in the detailed description of FIG. 2C and FIG. 2D. In preferred embodiments, the route data may include all routes to reach the destination location 421 from the starting location within the region 401.

Once the route data associated with the region 401 is obtained (or generated), the system 101 may be further configured to determine the mask data associated with the one or more routes 423, 425, and 427. In an example embodiment, the system 101 may determine the mask data associated with the one or more routes 423, 425, and 427 using the video data obtained from the one or more imaging devices. The determined mask data may include data about whether the previously traversed pedestrian(s) were wearing mask or not. In other words, the mask data may include data about whether the pedestrian 417 who traversed before the pedestrian 419 was wearing the mask or not. In an example embodiment, to determine the mask data using the video data, the system 101 may be configured to execute one or more mask determination models. For instance, the mask determination models may correspond to pre-trained AI models, pre-trained neural network models, and the like. For example, upon executing the one or more mask determination models, the system 101 may be configured to identify at least one target image portion in each image frame of the video data. For instance, the target image portion may correspond to an image portion where the pedestrian (e.g. the pedestrian 417) or the person is present. Further, the system 101 may clip the at least one target image portion in each of the image frames. Furthermore, the system 101 may assign a target id for each of the clipped target image portions such that the clipped target image portions corresponding to the same pedestrian are associated with similar target id. Furthermore, for each clipped target image portions with a unique target id, the system 101 may determine whether a mouth portion of the pedestrian (or the people) is covered with the mask or not. Since the determination of whether the mouth portion is covered with the mask or not is performed only of the clipped target image portions with the unique target ids, the system 101 may avoid repetitive mask checking for the same pedestrian who would be seen in next subsequent image frames. In this way, the system 101 may determine the mask data in an efficient manner using the video data, up on executing the one or more mask determination models.

Some embodiments are based on the recognition that within a given time period of the video data multiple pedestrians may have traversed through the one or more routes 423, 425, and 427. To this end, the system 101 may be further configured to determine a count of individuals (or the pedestrians) wearing the mask in each of the one or more routes 423, 425, and 427. For example, for each positive output determined to a particular route, the system 101 may increment a first counter value by ‘1’ to determine the count of individuals wearing the mask in that particular route. As used herein, the positive output may correspond to a result indicating that the pedestrian was wearing the mask. For instance, the positive output may be determined by the system 101 upon executing the one or more mask determination models. Accordingly, the mask data may further include the count of individuals (or the pedestrians) wearing the mask in each of the one or more routes 423, 425, and 427.

Further, the system 101 may be configured to determine a total count of individuals (or the pedestrians) in each of the one or more routes 423, 425, and 427. In an example embodiment, for each positive output and/or each negative output determined to a particular route, the system 101 may increment a second counter value by 1 to determine the total count of individuals in that particular route. As used herein, the negative output may correspond to a secondary result indicating that the pedestrian was not wearing the mask. For instance, the negative output may be determined by the system 101 upon executing the one or more mask determination models. Alternatively, in some other embodiments, the system 101 may execute a people count model on the video data to determine the total count of individuals in each of the one or more routes 423, 425, and 427. For instance, the people count model may correspond to a pre-trained AI model. For example, the people count model may be pre-trained using one or more training videos in which marks for individuals are provided by a developer.

Once the count of individuals wearing the mask and the total count of individuals in each of the one or more routes 423, 425, and 427 are determined, the system 101 may be configured to compute, for each of the one or more routes 423, 425, and 427, a ratio of (i) the count of individuals wearing the mask and (ii) the total count of individuals. For instance, the computed ratio (also referred to as a primary ratio) may be value from ‘0’ to ‘1’, where the ratio with the value ‘0’ indicating no individual is wearing the mask and the ratio with value ‘1’ indicating all individuals are wearing the mask. Further, the system 101 may be configured to a safety value for each of the one or more routes 423, 425, and 427 to produce a safety value set, based on the ratio computed for each of the one or more routes 423, 425, and 427. For instance, each element of the safety value set respectively corresponds to the safety value of a respective route in the one or more routes 423, 425, and 427. For instance, the system 101 may compute the safety value for a particular route by multiple a value of ‘100’ with the ratio associated with the particular route.

Further, the system 101 may be configured to generate the navigation data for navigating from the starting location to the destination location 421, based on the produced safety value set. In an example embodiment, the system 101 may determine the highest safety value in the safety value set by comparing each safety value with each other safety value. Further, the system 101 may identify a route that is associated with the highest safety value as the safest route. Furthermore, the system 101 may generate the navigation data comprising the safest route and the safety value associated with the safest route. In the example scenario illustrated in FIG. 4A and FIG. 4B, the system 101 may determine the routes 425 and 427 as the safest routes to reach the destination location 421 from the starting location, since the pedestrian 417 has traversed only a portion of the route 423 without the mask. In an example embodiment, when more than one route is determined as the safest route, the system 101 may determine an optimal route among the safest routes, based on the distance or length information associated with the safest routes. For instance, the route 425 may be determined as the optimal route since the distance from the starting location to the destination location 421 via the route 425 is less in comparison to the distance from the starting location to the destination location 421 via the route 427. Further, the system 101 may generate at least one navigation instruction (or guidance) for navigating from the starting location to the destination location 421 via the route 425. For instance, the at least one navigation instruction may be (i) voice instruction(s) directing the pedestrian 419 to traverse the route 425 to reach the destination location 421 and/or (ii) a video display instruction(s) showing directions to traverse the route 425 to reach the destination location 421.

Some embodiments are based on the realization that data about the sanitization performed for the one or more routes 423, 425, and 427 may affect the determination of the safest route. For example, even if the pedestrian 417 (e.g., an infected pedestrian) has traversed the route 423 (or the portion of the route 423) without wearing the mask, the next pedestrian 419 may not be affected from infectious diseases while traversing the route 423, given that the route 423 or the portion thereof is sanitized recently. To this end, the system 101 may be further configured to determine the sanitization data associated with the one or more routes 423, 425, and 427. In an example embodiment, the system 101 may be configured to determine the sanitization data associated with the one or more routes 423, 425, and 427 using the video data obtained from the one or more imagining devices. The determined sanitization data may include data about the sanitization performed for each of the one or more routes 423, 425, and 427. As used herein, ‘sanitization’ may correspond to cleaning, washing, or disinfecting the one or more routes 423, 425, and 427 with chemicals such as soap, detergents, or any other chemical composition with a predetermined percentage of alcohol. In an example embodiment, to determine the sanitization data using the video data, the system 101 may be configured to execute one or more sanitization data determination models. For instance, the one or more sanitization data determination models may be machine learning models, deep neural network models, and the like, which may be pre-trained to identify one or more sanitization persons in the one or more routes 423, 425, and 427 using the video data. In an example embodiment, the one or more sanitization data determination models may function similarly as the one or more mask determination models to identify one or more sanitization persons in the one or more routes 423, 425, and 427, where the target image portion may correspond to an image portion representing the sanitization person. For instance, the sanitization person may be differentiated from the pedestrian based on cleaning equipment(s) associated with the sanitization person. In this way, the system 101 may determine the sanitization data using the video data, upon executing the one or more sanitization data determination models.

Some embodiments are based on the recognition that within the given time period of the video data multiple sanitizations may be performed for each of the one or more routes 423, 425, and 427. To this end, the system 101 may be further configured to determine a frequency of the sanitization (e.g., cleaning) performed for each of the one or more routes 423, 425, and 427. For instance, the frequency of the sanitization may be indicative of a number of times the sanitization is performed within the time period of the video data. Further, the system 101 may determine a timestamp associated with each performed sanitization using the video data. Furthermore, the system 101 may determine a cleaning-type associated with each performed sanitization. For instance, the cleaning-type associated with one particular performed sanitization may be determined based on the cleaning equipment associated with the sanitization person. For example, the cleaning-type may be determined as determined as a complete cleaning, a partial cleaning, or the like. Accordingly, the sanitization data may further include one or a combination of: (i) the frequency of the sanitization performed for each of the one or more routes 423, 425, and 427, (ii) the timestamp associated with each performed sanitization, and/or (iii) the cleaning-type associated with each performed sanitization.

Further, the system 101 may be configured to generate the navigation data for navigating from the starting location to the destination location 421, based on one or a combination of the mask data and the sanitization data. In order to generate the navigation data based on one or combination of the mask data and the sanitization data, the system 101 may be configured to produce the safety value set based on the one or combination of the mask data and the sanitization data. In an example embodiment, to produce the safety value set based on the one or combination of the mask data and the sanitization data, the system 101 may be configured to compute a secondary ratio for each of the one or more routes 423, 425, and 427. For instance, the secondary ratio for one particular route may be computed by dividing the frequency of the sanitization performed for that particular route with the predetermined frequency value. For example, the predetermined frequency value may be a predetermined number of times the particular route should be sanitized within the given time period. Further, the system 101 may compute the safety value for each of the one or more routes 423, 425, and 427, based on the primary ratio and the secondary ratio computed for each of the one or more routes 423, 425, and 427.

For instance, to compute the safety value for one particular route, the system 101 may be configured to determine a first weight value and a second weight value for the particular route, based on time-stamp data associated with the video data. For instance, the time-stamp data may correspond to one or more timestamps associated with the sanitization data. Accordingly, the time-stamp data may include at least one time stamp indicating a time of a day at which a recent sanitization was performed for the particular route. The time-stamp data may alternately correspond to indicate a time when an individual without a mask passes an area and after a predetermined amount of time or a time decay, the area becomes safer (without sanitization) as a function of normal air flow.

In an example embodiment, the system 101 may compute a time difference between the current time instance and the timestamp associated with the recent sanitization performed for the particular route. Further, the system 101 may check whether the computed time difference is lesser than a predetermined time period. If the computed time difference is lesser than the predetermined time period, the system 101 may determine the first weight value and the second weight value such that the second weight value is greater than the first weight value. Conversely, if the computed time difference is not lesser than the predetermined time period, the system 101 may determine the first weight value and the second weight value such that the second weight value is lesser than the first weight value. Alternatively, in some other embodiments, the first weight value and the second weight value may be determined based on the cleaning-type associated with the recent sanitization. For instance, if the cleaning-type corresponds to the complete cleaning, the system 101 may determine the first weight value and the second weight value such that the second weight value is greater than the first weight value. Conversely, if the cleaning-type corresponds to the partial cleaning, the system 101 may determine the first weight value and the second weight value such that the second weight value is lesser than the first weight value.

Once the first weight value and the second weight value are determined for the particular route, the system 101 may determine a first weighted value based on the first weight value and the primary ratio associated with the particular route. For instance, the first weighted value may be determined by multiplying the first weight value and the primary ratio associated with the particular route. Further, the system 101 may determine second weighted value based on the second weight value and the secondary ratio associated with the particular route. For instance, the second weighted value may be determined by multiplying the second weight value and the secondary ratio associated with the particular route.

Once the first weighted value and the second weighted value are determined for the particular route, the system 101 may compute the safety value for the particular route, based on a combination of the first weighed value and the second weighted value. For instance, the safety value for the particular route may be computed by summing the first weighted value and the second weighted value and dividing the summation by a value of ‘2’. Similarly, the system 101 may compute the safety value for each of the one or more routes 423, 425, and 427 to produce the safety value set.

Once the safety value set is produced, the system 101 may determine the highest safety value in the safety value set by comparing each safety value with each other safety value. Further, the system 101 may identify the route that is associated with the highest safety value as the safest route. Furthermore, the system 101 may generate the navigation data comprising the safest route and the safety value associated with the safest route. Once the navigation data is generated, the system 101 may be configured to generate and provide the at least one navigation instruction for navigating from the starting location to the destination location 421 using the generated navigation data. For instance, the at least one navigation instruction may be (i) the voice instruction(s) and/or (ii) the video display instruction(s) providing direction(s) to the pedestrian to reach the destination location 421. Additionally, the system 101 may determine the lowest safety value in the safety value set by comparing each safety value with each other safety value. Once the lowest safety value in the safety value set is determined, the system 101 may identify a route that is associated with the lowest safety value as a vulnerable route. Further, the system 101 may be configured to generate a notification to a sanitization team (or hospitality team) to sanitize the vulnerable route.

In this way, the system 101 may generate the navigation data comprising the safest route to safely navigate the pedestrian from one location to another location within the region 401 such that the pedestrian have less chance of being exposed to the infectious diseases such as COVID or the like. Some embodiments are based on the realization that the one or more routes 423, 425, and 427 may have overlapping path segments, which may also affect the determination of the safest route. To this end, the system 101 may be configured to execute the operations for generating the navigation data at a path-segment-level rather than a route-level. For instance, the system 101 may generate the navigation data at the path-segment-level, as explained in the detailed description of FIG. 4C.

FIG. 4C illustrates a diagram 400c for generating the navigation based on the video data and path segments associated with the region 401, in accordance with one or more example embodiments. For instance, the pedestrian 419 may set the starting location and the destination location 421, as explained in the detailed description of FIG. 4B. Once the starting location and the destination location 421 are set, the system 101 may be configured to determine all routes (via map data, such as path segment and/or node data or, alternatively, a tile-based approach) to reach the destination location 421 from the starting location. For instance, the routes 423, 425, and 427 may be the possible routes to reach the destination location 421. Further, the system 101 may determine the path segments and the nodes associated with each of the possible routes using the map database 103a. For instance, path segments 429a, 429b, 429c, and 429d and nodes 431a, 431b, and 431c may be associated with the route 423. Similarly, path segments 429a, 429g, 429e, and 429d and nodes 431a, 431d, 431c may be associated with the route 425. Further, path segments 429a, 429h, 429f, 429e, and 429d and nodes 431f, 431e, 431d, and 431c may be associated with the route 427.

Once the path segments 429a, 429b, 429c, 429d, 429e, 429f, 429g, and 429h and the nodes 431a, 431b, 431c, 431d, 431e, and 431f are determined, the system 101 may be configured to determine the mask data associated with the path segments 429a, 429b, 429c, 429d, 429e, 429f, 429g, and 429h. For instance, the system 101 may determine the mask data associated with each of the path segments 429a, 429b, 429c, 429d, 429e, 429f, 429g, and 429h using the video data, as explained in the detailed description of FIG. 4B. The determined mask data may include data about whether the previously traversed pedestrian(s) were wearing the mask or not on each of the path segments 429a, 429b, 429c, 429d, 429e, 429f, 429g, and 429h. Additionally, the mask data may further include the count of individuals wearing the mask in each of the path segments 429a, 429b, 429c, 429d, 429e, 429f, 429g, and 429h. For instance, the system 101 determine the count of individuals wearing the mask in each of the path segments 429a, 429b, 429c, 429d, 429e, 429f, 429g, and 429h using the video data, as explained in the detailed description of FIG. 4B.

Further, the system 101 may be configured to determine the sanitization data associated with the path segments 429a, 429b, 429c, 429d, 429e, 429f, 429g, and 429h. For instance, the system 101 may determine the sanitization data associated with each of the path segments 429a, 429b, 429c, 429d, 429e, 429f, 429g, and 429h using the video data, as explained in the detailed description of FIG. 4B. The determined sanitization data may include data about the sanitization performed for each of the path segments 429a, 429b, 429c, 429d, 429e, 429f, 429g, and 429h. Additionally, the sanitization data may include: (i) the frequency of the sanitization performed for each of the path segments 429a, 429b, 429c, 429d, 429e, 429f, 429g, and 429h, (ii) the timestamp associated with each performed sanitization, and/or (iii) the cleaning-type associated with each performed sanitization.

Furthermore, the system 101 may determine a total count of individuals in each of the path segments 429a, 429b, 429c, 429d, 429e, 429f, 429g, and 429h. For instance, the system 101 may determine the total count of individuals in each of the path segments 429a, 429b, 429c, 429d, 429e, 429f, 429g, and 429h using the video data, as explained in the detailed description of FIG. 4B. Furthermore, the system 101 may compute, for each of the path segments 429a, 429b, 429c, 429d, 429e, 429f, 429g, and 429h, a primary ratio of the count of individuals wearing the mask and the total count of individuals. For instance, the system 101 may compute the primary ratio for each of the path segments 429a, 429b, 429c, 429d, 429e, 429f, 429g, and 429h as explained in the detailed description of FIG. 4B. Furthermore, the system 101 may compute the secondary ratio for each of the path segments 429a, 429b, 429c, 429d, 429e, 429f, 429g, and 429h as explained in the detailed description of FIG. 4B. Furthermore, the system 101 may compute the safety value for each of the path segments 429a, 429b, 429c, 429d, 429e, 429f, 429g, and 429h to produce the safety value set, based on the primary ratio and the secondary ratio computed for each of the path segments 429a, 429b, 429c, 429d, 429e, 429f, 429g, and 429h.

For instance, to compute the safety value for a particular path segment, the system 101 may configured to determine the first weight value and the second weight value for the particular path segment, based on the time stamp data. Further, the system 101 may be configured to determine the first weighted value based on the first weight value and the primary ratio associated with the particular path segment. Furthermore, the system 101 may be configured to determine the second weighted value based on the second weight value and the secondary ratio associated with the particular path segment. Furthermore, the system 101 may be configured to compute the safety value for the particular path segment based on the first weight value and the second weighted value. In this way, the system 101 may compute the safety value for each the path segments 429a, 429b, 429c, 429d, 429e, 429f, 429g, and 429h to produce the safety value set.

Once the safety value set is produced, the system 101 may be configured to determine a route that is safe for navigating from the starting location to the destination location 421. In an example embodiment, to determine the route that is safe for navigating, the system 101 may be configured to determine one or more path segments that are associated with the safety values which are greater than a predetermined safety value. For instance, the safety values of the path segments 429a, 429d, 429e, 429f, 429g, 429h may be greater than the predetermined safety value, since the pedestrian 417 had traversed only the path segments 429b and 429c without wearing the mask. Further, the system 101 may determine the route that is safe for navigating from the starting location to the destination location 421, using the determined one or more path segments (i.e., the path segments 429a, 429d, 429e, 429f, 429g, 429h). Additionally, the system 101 may display the safety value in the form of percentage of safety value associated with each of the path segments or percentage of safety value associated with each route from starting location to the destination location. Based, on this display, the route that is safe for navigating for generating the navigation data may be selected. The selection of this route that is safe for travelling may be done manually by user by choosing the route or path segments with highest percentage safety values. Alternately, the selection of the route may be done automatically by the system 101, based on the displayed percentage of safety values, by choosing the route or path segments with highest percentage safety values. To that end, the determined route may correspond to the navigation data. Once the route that is safe for navigating from the starting location to the destination location 421 is determined, the system 101 may be configured to generate the at least one navigation instruction (or the guidance) for navigation of the pedestrian 419 to reach the destination location 421, based on the determined route. For instance, the at least one navigation instruction may be (i) the voice instruction(s) and/or (ii) the video display instruction(s) providing direction(s) to the pedestrian to reach the destination location 421. The video display may also represent visually the percentage of safety values for each route or for each path segment, as illustrated in FIG. 4D.

FIG. 4D illustrates a diagram showing a visual representation of the generated navigation data based on percentage safety values associated with different routes of navigation. There are two routes displayed to the pedestrian 419: Route A comprising of portions (or path segments) 429a, 429g, 429e, and 429d; and Route B comprising of portions 429a, 429b, 429c, and 429d. Route A is displayed to the pedestrian 419 with an associated safety value of 90%, while route B is displayed to the pedestrian 419 with an associated safety value of 60%. Thus, compared to route B, route A is safer, as it has higher safety value. Therefore, route A may be determined as the “safest” route for the pedestrian 419 to navigate to the destination location 421.

The safest route may be then exclusively displayed to the pedestrian, or an audio may be generated to indicate the safest route (like route A in this example), to generate navigation data for the pedestrian 419.

In some embodiments, instead of displaying the safety values for the routes, the safety values for each portion or path segment are displayed or provided to the user. Then, the safest route is determined as the route which combines the portions with higher safety values (compared to portions with lower safety values) to form a route to reach the destination location 421.

Further, the safety values are changed and updated from time to time, or in substantially real-time, and accordingly the safety values of different routes (or portions thereof) are also updated. For example, Route A is 90% safe at a current time and route B is 60% safe. Correspondingly a map display, such as the display shown in FIG. 4D, can show the route or portion thereof with an associated safety percentage. Then, one person might walk through the route A (or portion thereof, such as through path segment 429e) without wearing a mask. Then, the safety values are recalculated for the different portions through which the person travelled, and correspondingly, the overall safety value for the route A is also recalculated. This time, the safety value may be determined to be 50%. The map display is then updated to reflect this change in the safety value. Also, now route B becomes the safest route for the pedestrian to travel to destination 421, in comparison with route A, as now the safety value of route B, which is still 60%, is higher than the safety value of route A.

Furthermore, based on this determination that the safety value of route A has suddenly dropped from 90% to 50%, or as part of a normal cleaning schedule, a cleaning personnel may be sent to sanitize all the path segments comprised by route A, such as path segment 429a, path segment 429g, path segment 429e, and path segment 429d. Accordingly, the safety values of all the path segments 429a, 429g, 429e, and 429d are recalculated. Now, the overall safety value of route A may become 99%. Accordingly route A again becomes the safest route for the pedestrian 419 to travel to destination 421.

Thus, the system 101 may be continually configured to update the safety values and navigation data in substantially real-time, for providing safest route of navigation for any pedestrian.

In this way, the system 101 may execute the operation(s) at the path segment level to determine the route that is safe for navigating from one location to another location within the region 401. Further, it may not be limited to the path segment level, in some implementations, a grid (such as the grid 213) may be placed on a layout of the region 401 and further the operation(s) to determine the route that is safe for navigating from one location to another location within the region 401 may be executed a tile level of the applied grid. Furthermore, the disclosed system 101 for generating the navigation data may not be limited to only indoor regions. In some implementations, the system 101 may generate the navigation data comprising the safest route for outdoor regions such as geographic regions. In these implementations, the path segments may correspond to roads in which one or more vehicles travel and the routes may correspond to road networks comprising one or multiples roads and their corresponding intersections.

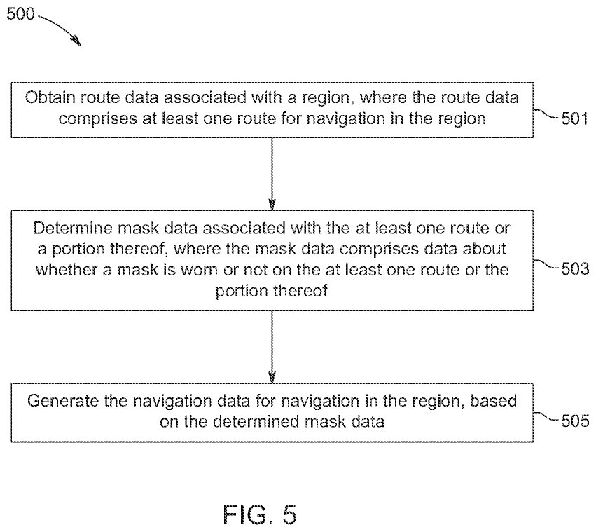

FIG. 5 illustrates a flowchart depicting a method 500 for generating the navigation data, in accordance with one or more example embodiments. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 303 of the system 101, employing an embodiment of the present disclosure and executed by the processor 301. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. Also, different, fewer, or additional blocks or steps may be provided.

Starting at block 501, the method 500 may include obtaining the route data associated with the region. For instance, the system 101 may obtain the route data associated with the region 401. The route data may comprise at least one route (such as the routes 423, 425, and 427) for navigation in the region.

At block 503, the method 500 may include determining the mask data associated with the at least one route or a portion thereof. For instance, the system 101 may determine the mask data associated with the routes 423, 425, and 427 or the path segments of the routes 423, 425, and 427. The determined mask data may include data about whether the mask is worn or not on the routes 423, 425, and 427 (or the path segments of the routes 423, 425, and 427). Additionally, at block 503, the method 500 may further include determining the sanitization data associated with the at least one route or the portion thereof. For instance, the system 101 may determine the sanitization data associated with the routes 423, 425, and 427 or the path segments of the routes 423, 425, and 427. The determined sanitization data may include data about the cleaning performed for the routes 423, 425, and 427 (or the path segments of the routes 423, 425, and 427).

At block 505, the method 500 may include generating the navigation data for navigation in the region, based on the determined mask data. Additionally, at block 505, the method 500 may further include generating the navigation data based on one or a combination of the mask data and the sanitization data. For instance, the system 101 may generate the navigation data based on one or a combination of the mask data and the sanitization data, as explained in the detailed description of FIG. 4A and FIG. 4B. For instance, the generated navigation data may include the safest route for the navigation in the region. As used herein, the safest route may correspond to the route in which the precautionary protocols (such as wearing masks, frequent sanitization, and the like) have been taken for ensuring safety from the infectious diseases.

On implementing the method 500, the system 101 may generate the navigation data comprising the safest route to safely navigate the pedestrian from one location to another location within the region such that the pedestrian have less chance of being exposed to the infectious diseases such as COVID or the like.

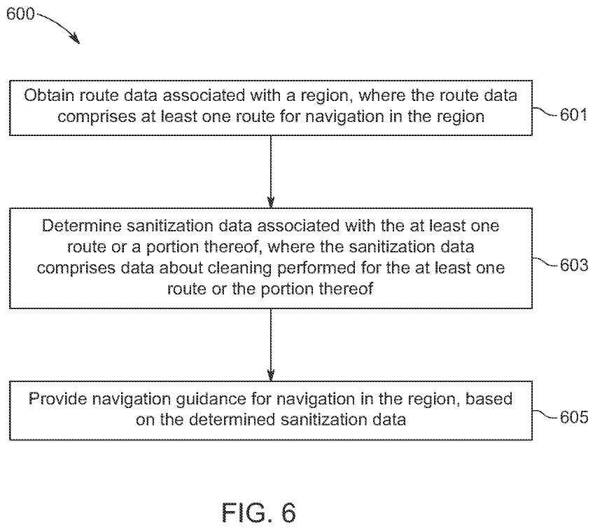

FIG. 6 illustrates another flowchart depicting a method 600 for providing navigation guidance for navigation in a region, in accordance with one or more example embodiments. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 303 of the system 101, employing an embodiment of the present disclosure and executed by the processor 301. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. Also, different, fewer, or additional blocks or steps may be provided.

Starting at block 601, the method 600 may include obtaining the route data associated with the region. For instance, the system 101 may obtain the route data associated with the region 401. The route data may comprise at least one route (such as the routes 423, 425, and 427) for navigation in the region 401.

At block 603, the method 600 may include determining sanitization data associated with the at least one route or a portion thereof. For instance, the system 101 may determine the sanitization data associated with the routes 423, 425, and 427 or the path segments of the routes 423, 425, and 427. The determined sanitization data may include data about the cleaning performed for the routes 423, 425, and 427 (or the path segments of the routes 423, 425, and 427).

The sanitization data may further include data about multiple factors such as a frequency of the cleaning performed for the at least one route or the path segment, a timestamp associated with the cleaning, and a cleaning type associated with the cleaning. The timestamp corresponds to the time of the day at which the corresponding sanitization is performed. Each of these factors is assigned a weight value. For example, the computations of first weight value and second weight value discussed in FIG. 4B are used for such an assignment. These weight values are then used to determine weighted values for each route or path segment, whose combination is then further used to determine the safety value for that particular route or path segment. The timestamp may be determined for the recent sanitization, such as by determining timestamp within a threshold range of a current time of the day.

Such sanitization data may be obtained from a database which may be maintained by the mapping platform 103. Alternatively, the sanitization data may be maintained by a third-party server, which may transmit the data periodically to the mapping platform 103, which further transmits the data to the system 101, for further processing. For example, the sanitization data determination module 301c of the system 101 may be configured to use the data to determine the frequency or time of cleaning performed for the path segments or the routes in the region 401, as depicted herein.

At block 605, the method 600 may include providing navigation guidance for navigation in the region, based on the determined sanitization data. For instance, the system 101 may provide navigation guidance via audio or video instructions, as explained in the detailed description of FIGS. 4A-FIG. 4D. For instance, the generated navigation guidance may include displaying the safest route for the navigation in the region 401, displaying safety percentage values for the different routes or path segments in the region 401, providing audio-based turn-by-turn guidance to the user for reaching their destination location based on the safest route determined by the system 101, or a combination thereof. To that end, the system 101 is configured to compute a safety value for each route or path segment in the region. The determined safety values for all such routes and the path segments forms a safety value set. This safety value set is then used to identify the safest route among all possible routes for a pedestrian or the user to reach their destination. For example, the route with the highest safety value in the safety value set may be determined as the safest route.

The safest route is then used to generate navigation data, such as in the form of turn-by-turn instructions for reaching the desired destination of the user, based on the safest route. The navigation data is then used to provide the navigation guidance to the user, in the form of audio, video or a combination of audio and video-based outputs.

In some embodiments, the route with lowest safety value in the safety value set is identified as a vulnerable route, and correspondingly, a notification or an alert is generated fir sanitization of the vulnerable route. The notification may be sent to the sanitization department associated with the region 401, or to the mapping platform 103, which are configured to take further action based on receiving of such an alert.

In some embodiments, the method 600 further comprises mask data as well for each of the path segments or the routes in the region 401, as has already been described in conjunction with FIGS. 4A-4D, and FIG. 5. The mask data provides video data associated with a count of individuals wearing a mask in each of the at least one route or the portion thereof, as compared to the total count of the individual in each of the at least one route or the portion thereof, to calculate a ratio. The ratio gives the count of individuals wearing the mask to the total count of individuals, for that particular route or path segment. Then, this ratio is additionally used as a parameter for calculating the safety value for that particular route or path segment, as has already been described in FIG. 4B-4D.

As used herein, the safest route may correspond to the route in which the precautionary protocols (such as wearing masks, frequent sanitization, and the like) have been followed for ensuring safety from the infectious diseases.

On implementing the method 600, the system 101 may generate the navigation data comprising the safest route to safely navigate the pedestrian from one location to another location within the region such that the pedestrian have less chance of being exposed to the infectious diseases such as COVID or the like.

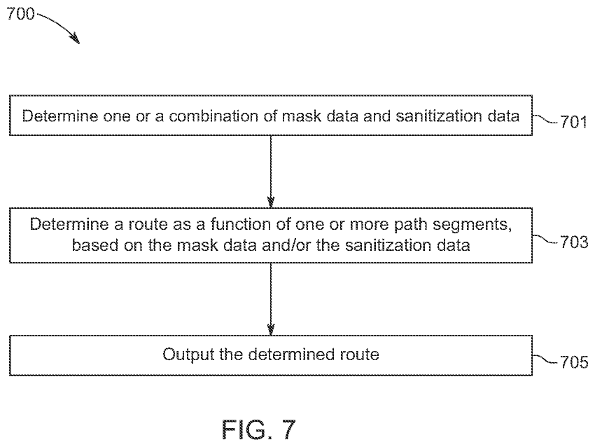

FIG. 7 illustrates yet another flowchart 700 depicting a method 700 for generating the navigation data, in accordance with one or more example embodiments. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 303 of the system 101, employing an embodiment of the present disclosure and executed by the processor 301. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. Also, different, fewer, or additional blocks or steps may be provided.

Starting at block 701, the method 700 may include determining one or a combination of the mask data and sanitization data associated with one or more path segments in the region. The determination may be made by deriving data from the mapping platform 103, or from a third-party server, or by a combination of both.

For instance, the system 101 may obtain the mask data and the sanitization associated with the region 401. The region data may comprise at least one route (such as the routes 423, 425, and 427) for navigation in the region and multiple path segments 429a, 429b, 429c, 429d, 429e, 429f, 429g, and 429h. The mask data about each path segment provides data about whether a mask is worn or not on the one or more path segments, as has already been described in FIG. 4A—4D. Similarly, data about sanitization comprises data about a cleaning performed for the one or more path segments, which has also been described previously.

For instance, the system 101 may determine the mask data associated with the routes 423, 425, and 427 or the path segments of the routes 423, 425, and 427. The determined mask data may include data about whether the mask is worn or not on the routes 423, 425, and 427 (or the path segments of the routes 423, 425, and 427). Additionally, the method 700 may further include determining the sanitization data associated with the at least one route or the portion thereof. For instance, the system 101 may determine the sanitization data associated with the routes 423, 425, and 427 or the path segments of the routes 423, 425, and 427. The determined sanitization data may include data about the cleaning performed for the routes 423, 425, and 427 (or the path segments of the routes 423, 425, and 427). Once such mask data and sanitization for each portion of each route, which is each path segment, is determined, the method 700 proceeds to block 703.

At block 703, the method 700 may include determining a route as a function of the one or more path segments, for navigation in the region, based on at least one of the determined mask data, the sanitization data, or a combination thereof. For instance, as discussed in FIG. 4C, the route 423 is a function of path segments 429a, 429b, 429c, and 429d. Similarly route 425 is a function of path segments 429a, 429g, 429e, and 429d. And route 427 is a function of path segments 429a, 429h, 429f, 429e, and 429d. To that end, the function may be a simple combination of parts. The combination may also be a summation of various parts. The function is used to combine the mask data and the sanitization data of each of the path segments to determine the combined mask data and sanitization data for the entire route.

For instance, the combined mask data and sanitization data for the path segments forming the route is used to determine the overall safety value for the route, based on safety value sets of each of the individual path segments. The computations of safety value set and a selection of highest safety value from the set to find the route, has already been discussed in FIG. 4A-4D.

Finally, at block 705, the determined route is outputted, such as to the user via audio or video output data. For instance, as shown in FIG. 4D, the route may be displayed with its associated safety value in the form of percentage safety, for the user to decide their path of navigation.

Thus, on implementing the method 700, the system 101 may generate the navigation data comprising the safest route to safely navigate the pedestrian from one location to another location within the region such that the pedestrian have less chance of being exposed to the infectious diseases such as COVID or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for generating navigation data, the system comprising:
a memory configured to store computer-executable instructions; and
at least one processor configured to execute the computer-executable instructions to:
obtain route data associated with a region, wherein the route data comprises at least one route for navigation in the region;
determine mask data associated with the at least one route or a portion thereof, wherein the mask data comprises data about whether a mask is worn or not on the at least one route or the portion thereof; and
generate the navigation data for navigation in the region, based on the determined mask data.

2. The system of claim 1, wherein to generate the navigation data based on the mask data, the at least one processor is configured to:
compute a safety value for each of the at least one route or the portion thereof to produce a safety value set; and
generate the navigation data for the navigation in the region, based on the safety value set.

3. The system of claim 2, wherein to generate the navigation data based on the safety value set, the at least one processor is configured to:
identify a route that is associated with highest safety value in the safety value set, as a safest route; and
generate the navigation data comprising the safest route and the safety value associated with the safest route.

4. The system of claim 2, wherein the at least one processor is further configured to:
identify a route that is associated with the lowest safety value as a vulnerable route; and
generate a notification to sanitize the vulnerable route.

5. The system of claim 2, wherein the mask data further comprises a count of individuals wearing the mask in each of the at least one route or the portion thereof, and wherein to produce the safety value set, the at least one processor is configured to:
determine, using video data associated with the region, a total count of individuals in each of the at least one route or the portion thereof,
compute, for each of the at least one route or the portion thereof, a ratio of (i) the count of individuals wearing the mask and (ii) the total count of individuals; and
compute the safety value for each of the at least one route or the portion thereof, based on the computed ratio.

6. The system of claim 5, wherein the at least one processor is further configured to:
determine sanitization data associated with the at least one route or the portion thereof, based on the video data, wherein the sanitization data comprises one or a combination of: (i) a frequency of a cleaning performed for the at least one route or the portion thereof, (ii) a timestamp associated with each cleaning, and (iii) a cleaning-type associated with each cleaning; and
compute the safety value for each of the at least one route or the portion thereof, based on one or a combination of the computed ratio and the sanitization data.

7. The system of claim 6, wherein to compute the safety value for a particular route or the portion thereof, the at least one processor is further configured to:
determine a first weight value and a second weight value for the particular route or the portion thereof, based on time-stamp data associated with the video data;
determine a first weighted value based on the first weight value and the ratio associated with the particular route or the portion thereof;
determine a second weighted value based on the second weight value and the frequency of sanitization associated with the particular route or the portion thereof; and
compute the safety value for the particular route or the portion thereof based on a combination of the first weighted value and the second weighted value.

8. The system of claim 7, wherein the time-stamp data comprises a timestamp associated with time of day at which a recent sanitization is performed for the particular route or the portion thereof.

9. The system of claim 1, wherein the at least one processor is further configured to provide at least one navigation instruction to reach a destination location in the region, based on the generated navigation data.

10. A method for providing navigation guidance, the method comprising:
obtaining route data associated with a region, wherein the route data comprises at least one route for navigation in the region;
determining sanitization data associated with the at least one route or a portion thereof, wherein the sanitization data comprises data about a cleaning performed for the at least one route or the portion thereof; and
providing navigation guidance for navigation in the region, based on the determined sanitization data.

11. The method of claim 10, wherein providing the navigation guidance based on the determined sanitization data comprises:
computing a safety value for each of the at least one route or the portion thereof to produce a safety value set;
generating navigation data, based on the safety value set; and
providing the navigation guidance, based on the navigation data.

12. The method of claim 11, wherein generating the navigation data based on the safety value set comprises:
identifying a route that is associated with a highest safety value in the safety value set as the safest route; and
generating the navigation data comprising the safest route and the safety value associated with the safest route.

13. The method of claim 11, further comprising:
identifying a route that is associated with a lowest safety value in the safety value set as a vulnerable route; and
generating a notification to sanitize the vulnerable route.

14. The method of claim 11, wherein producing the safety value set comprises:
determining mask data associated with the at least one route or the portion thereof, using video data associated with the region, wherein the mask data comprises a count of individuals wearing a mask in each of the at least one route or the portion thereof;
determining, using the video data, a total count of individuals in each of the at least one route or the portion thereof;
computing, for each of the at least one route or the portion thereof, a ratio of (i) the count of individuals wearing the mask and (ii) the total count of individuals; and
computing the safety value for each of the at least one route or the portion thereof, based on one or a combination of the computed ratio and the sanitization data.

15. The method of claim 14, wherein the sanitization data further comprises one or a combination of: (i) a frequency of the cleaning performed for the at least one route or the portion thereof, (ii) a timestamp associated with each cleaning, and (iii) a cleaning-type associated with each cleaning, and wherein computing the safety value for a particular route or the portion thereof comprises:
determining a first weight value and a second weight value for the particular route or the portion thereof, based on time-stamp data associated with the video data;
determining a first weighted value based on the first weight value and the ratio associated with the particular route or the portion thereof;
determining a second weighted value based on the second weight value and the frequency of sanitization associated with the particular route or the portion thereof; and
computing the safety value for the particular route or the portion thereof based on a combination of the first weighted value and the second weighted value.

16. The method of claim 15, wherein the time-stamp data comprises a timestamp associated with time of day at which a recent sanitization is performed for the particular route or the portion thereof.

17. A computer program product comprising a non-transitory computer readable medium having stored thereon computer executable instructions which when executed by at least one processor, cause the at least one processor to conduct operations for determining a route, the operation comprising:
determining one or a combination of mask data and sanitization data associated with one or more path segments of a region, wherein: (i) the mask data comprises data about whether a mask is worn or not on the one or more path segments, and (ii) the sanitization data comprises data about a cleaning performed for the one or more path segments;
determining the route, as a function of the one or more path segments, for navigation in the region, based on at least one of the determined mask data, the sanitization data, or a combination thereof; and
outputting the determined route.

18. The computer program product of claim 17, wherein for determining the route based on at least one of the determined mask data, the sanitization data, or a combination thereof, the operations further comprise:
computing a safety value for each of the one or more path segments to produce a safety value set; and
determining the route for the navigation in the region, based on the safety value set.

19. The computer program product of claim 18, wherein the mask data further comprises a count of individuals wearing the mask in each of the one or more path segments, wherein the sanitization data further comprises one or a combination of: (i) a frequency of the cleaning performed for each of the one or more path segments, (ii) a time-stamp associated with each cleaning, and (iii) a cleaning-type associated with each cleaning, and wherein for producing the safety value set, the operations further comprise:
determining, using video data associated with the region, a total count of individuals in each of the one or more path segments;
computing, for each of the one or more path segments, a ratio of (i) the count of individuals wearing the mask and (ii) the total count of individuals; and
computing the safety value for each of the one or more path segments, based on one or a combination of the computed ratio and the sanitization data.

20. The computer program product of claim 19, wherein for computing the safety value for a particular path segment, the operations further comprising:
determining a first weight value and a second weight value for the particular path segment, based on time-stamp data associated with the video data;
determining a first weighted value based on the first weight value and the ratio associated with the particular path segment;
determining a second weighted value based on the second weight value and the frequency of sanitization associated with the particular path segment; and
computing the safety value for the particular path segment based on a combination of the first weighted value and the second weighted value.
